(19) United States
(12) Patent Application Publication
(10) Pub. No.: US 2002/0124425 A1
(43) Pub. Date: Sep. 12, 2002

(54) Bubble vial reference markings

(76) Inventor: Emanuel Hillel Szumer, M.P. Bikat Beit Hakerem (IL)

Correspondence Address: DEKEL PATENT LTD . , DAVID KLEIN, BEIT HAROFIM, 18 MENUHA VENAHALA STREET, ROOM 27, REHOVOT, IL

(21) Appl. No.: 09/803,673

(22) Filed: Mar. 12, 2001

(51) Int. Cl. G01C 9/10

(52) U.S. Cl. 33/365

(57) ABSTRACT

A method for marking a bubble vial, including providing a bubble vial body having an internal cavity for holding therein a fluid, the cavity defining an inner surface of the body, and inking a reference marking on the inner surface.

### FIELD OF THE INVENTION

The present invention relates generally to bubble vials and methods for their construction, and particularly to a bubble vial with internal reference markings and methods for making such markings.

### BACKGROUND OF THE INVENTION

Spirit levels are well known instruments used to plumb or set surfaces, such as horizontal or vertical surfaces. Spirit levels generally include one or more bubble vials, in which a fluid (e.g., mineral spirits, kerosene, or similar substances) is encapsulated within a sealed transparent (or at least translucent) body with an air space providing a visible bubble. Although glass was originally used to make bubble vials, today acrylic is the material predominantly used for making molded vials, although other plastics are also used.

One type of bubble vial is a tubular bubble vial, comprising an elongate transparent tube with a slight curvature formed therein. When the bubble vial is positioned substantially horizontally, the air bubble rises to the top of the curvature and is situated between two markings, transverse to the longitudinal axis of the body. Another well-known bubble vial has a “bull's-eye” configuration. Such a vial body has a generally spherical configuration so that the air bubble will be positioned in the center or bull's eye of one or more concentric series of circular markings on the spherical body, when the vial body is placed on a horizontal plane. Tubular bubble vials are generally used for checking the level of a surface or object in one dimension, whereas bull's-eye bubble vials may be used to check the level of a plane, i.e., two dimensions at once.

The reference markings used to indicate the relative position of the bubble in the bubble vial may be marked on the internal or external surface of the vial. One example of an external marking is that of marking rings fixed over the circumference of a tubular body. In the case of bull's-eye bubble vials, markings are generally inked on the exterior surface of the vial during post-manufacturing calibration procedures. External markings have a drawback of being somewhat exposed to contact by foreign objects, and can be worn or chipped away over time.

Internal rings are generally used in the art for making internal markings in tubular bubble vials. For example, U.S. Pat. No. 4,347,088 to Jacquet, assigned to Stanley of France, describes a method for manufacturing a tubular bubble vial. A barrel-shaped inner cavity is machined in a preform, and inner grooves are machined to receive circlips. A circlip is a type of snap ring with an almost completely circular shape, having a discontinuity or opening about the perimeter so that the ring can be deformed radially for insertion into the groove formed in the barrel-shaped cavity.

A problem with such a construction is that the surface transition between the circlip and the inner wall of the tube is not smooth, because the circlip is not flush with the inner surface of the wall, due to manufacturing and assembly tolerances. The result is that a slight edge is presented to a bubble moving along the vial and such an edge may cause the bubble to “hang up” in its travel and yield an inaccurate reading. More importantly, assembly of the circlips in the tubular body is expensive in terms of labor and time.

U.S. Pat. No. 5,651,186 to Lindner et al., assigned to Empire Level Manufacturing Corp., Milwaukee, Wisconsin, US, attempts to solve the “hang up” problem of the circlips. Lindner et al. uses a marker ring which is machined flush with the rest of the tubular body wall. Specifically, a marker ring is mounted within a mold cavity by means of a pin and the mold is filled with a hot plastic material, typically acrylic. After filling the mold, the acrylic is permitted to cool so that the acrylic and the marker ring bond to one another for subsequent machining. The acrylic and the marker ring are machined so as to have a coextensive, slightly curvilinear surface. There are no significant grooves or edges on which a bubble vial bubble can “snag” or “hang up”. However, the method of Lindner et al. is very time-consuming and expensive.

### SUMMARY OF THE INVENTION

The present invention seeks to provide an improved method for making internal reference markings in a bubble vial, as is described in detail hereinbelow.

There is thus provided in accordance with a preferred embodiment of the present invention a method for marking a bubble vial, including providing a bubble vial body having an internal cavity for holding therein a fluid, the cavity defining an inner surface of the body, and inking a reference marking on the inner surface.

In accordance with a preferred embodiment of the present invention the inking includes inserting inside the cavity a marking nib, the nib being adapted for applying an ink line on a surface, aligning the nib with a selected area of the inner surface and imparting relative motion between the nib and the inner surface so as to form the reference marking on the inner surface.

Further in accordance with a preferred embodiment of the present invention the marking nib is generally stationary and the inner surface of the bubble vial body is moved relative to the nib. Alternatively, the inner surface of the bubble vial body may be generally stationary while the marking nib is moved relative to the inner surface of the bubble vial body.

In accordance with a preferred embodiment of the present invention, the marking nib may contact the inner surface during the inking. Alternatively, the marking nib is adapted to ink jet ink upon a surface, and the reference marking is ink jetted on the inner surface.

Further in accordance with a preferred embodiment of the present invention, the method includes, prior to the inking, machining the inner surface.

Still further in accordance with a preferred embodiment of the present invention the machining is performed with a cutting tool held in a machine tool setup, and the inking includes inserting inside the cavity a marking nib held in the machine tool setup, the nib being adapted for applying an ink line on a surface, aligning the nib with a selected area of the inner surface and imparting relative motion between the nib and the inner surface so as to form the reference marking on the inner surface.

In accordance with a preferred embodiment of the present invention the inner surface includes a non-absorbent surface and the inking includes forming the reference marking with an ink having an ink film fixability sufficient for adhering to the non-absorbent surface.

Additionally in accordance with a preferred embodiment of the present invention a groove is formed in the inner surface of the vial body, and the reference marking is formed in the groove.

There is also provided in accordance with a preferred embodiment of the present invention a bubble vial including a bubble vial body having an internal cavity for holding therein a fluid, the cavity defining an inner surface of the body, and a reference marking inked on the inner surface.

In accordance with a preferred embodiment of the present invention the bubble vial body is of generally tubular shape with an internal circumference, and the reference marking is formed on at least a portion of the internal circumference, generally transverse to a longitudinal axis of the bubble vial body.

In accordance with another preferred embodiment of the present invention the bubble vial body is of generally spherical shape with an internal dome, and the reference marking is formed on at least a portion of the internal dome.

### BRIEF DESCRIPTION OF THE DRAWINGS

The present invention will be understood and appreciated more fully from the following detailed description taken in conjunction with the drawings in which:

FIGS. 1A-1C are simplified, partially sectional illustrations of a method for marking a bubble vial, in accordance with a preferred embodiment of the present invention, wherein

FIG. 1A illustrates machining an inner surface of an inner cavity of a bubble vial body, and

FIGS. 1B and 1C illustrate inking reference markings on the inner surface of the bubble vial body;

FIG. 2 is a simplified, partially sectional illustration of using an ink jet to make the reference markings, in accordance with a preferred embodiment of the present invention;

FIGS. 3A and 3B are simplified pictorial illustrations of two different machine tool setups with a cutting tool, used to machine the inner surface of the bubble vial body, and marking nib, used to make the reference markings, in accordance with preferred embodiments of the present invention; and

FIGS. 4 and 5 are simplified pictorial illustrations of tubular and spherical bubble vial bodies, respectively, constructed and operative in accordance with two preferred embodiments of the present invention.

### DETAILED DESCRIPTION OF A PREFERRED EMBODIMENT

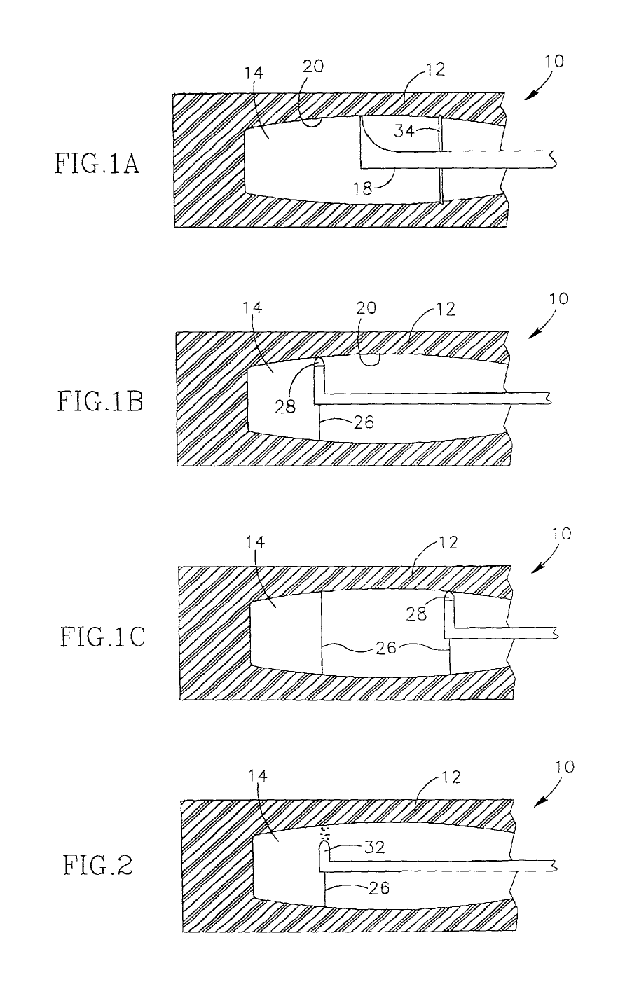

Reference is now made to FIGS. 1A-1C, which illustrate a method for marking a bubble vial 10, in accordance with a preferred embodiment of the present invention.

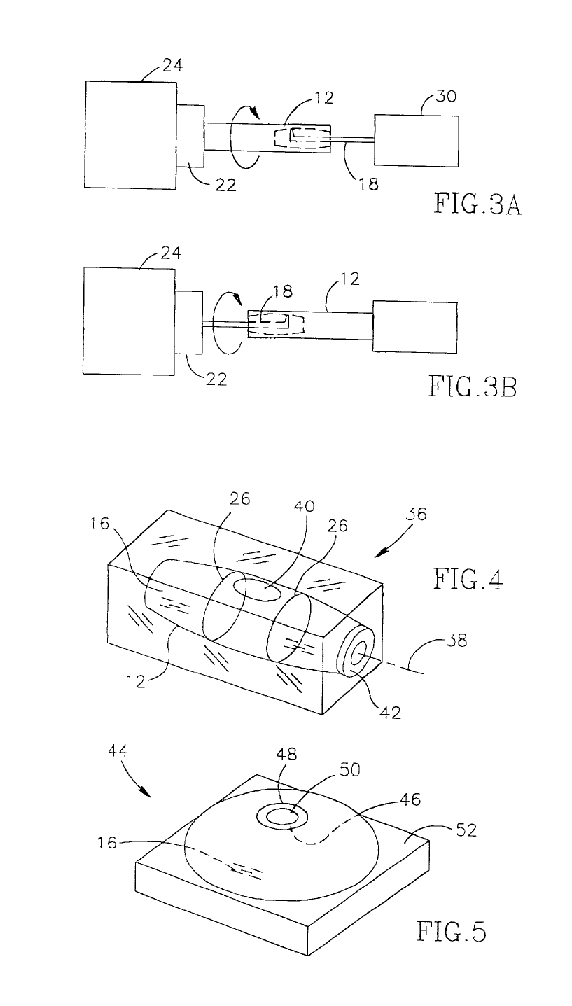

Bubble vial 10 includes a bubble vial body 12 having an internal cavity 14 for holding therein a fluid 16 (seen in FIGS. 4 and 5). Bubble vial body 12 may be made of any suitable material used for making bubble vials, such as acrylic. As seen in FIG. 1A, internal cavity 14 may be machined out of body 12 with a cutting tool 18, which forms an inner surface 20 in cavity 14. As seen in FIG. 3A, body 12 may be held in a collet or chuck 22 of a machine tool 24, such as a lathe, milling machine and the like, as cutting tool 18 machines the interior of body 12. In such a case, body 12 turns and cutting tool 18 is stationary. Alternatively, as seen in FIG. 3B, cutting tool 18 may be held in chuck 22, with the interior of body 12 being brought to the cutting edge of cutting tool 18. In such a case, cutting tool 18 turns and body 12 is stationary. As a further alternative, internal cavity 14 and its inner surface 20 may be molded as an integral part of body 12, without need for further machining.

Reference is now made again to FIGS. 1B and 1C. In accordance with a preferred embodiment of the present invention, a reference marking 26 is inked on inner surface 20. One way of accomplishing this is by inserting inside cavity 14 a marking nib 28. Marking nib 28 is adapted for applying an ink line on a surface. As noted hereinabove, a preferred material for bubble vial body 12 is a plastic such as acrylic, which is generally a non-absorbent surface. Inks are readily available for inking non-absorbent surfaces, wherein the ink forms a permanent bond with the non-absorbent substrate after drying or curing. In other words, the ink has an ink film fixability (i.e., a fastness of drawn lines) sufficient for adhering to the nonabsorbent surface and forming an indelible marking. Examples of such inks are described in U.S. Pat. No. 6,039,795 to Fukuo et al., the disclosure of which is incorporated herein by reference. Examples of such inks include, but are not limited to, ink compositions comprising a coloring agent, an organic polar solvent, an oil-soluble resin and an organically modified silicone as principal components thereof. The organically modified silicone may include dimethyl silicone, alkyl-modified silicones, polyether-modified silicones such as a polyoxypropylene modified silicone and the like, for example. The organic polar solvent may include alcohol solvents or glycol ether solvents, for example. The oil-soluble resin may include ketone resins, phenol resins, xylene resins, rosin resins, styrene-organic acid copolymers and polyacrylates, for example. The particular ink used depends, inter alia, upon the type of non-absorbent surface and compatibility with the fluid used in the bubble vial.

Marking nib 28 may be held in the same machine tool setup as cutting tool 18. For example, machine tool 24 may have a head 30 for holding more than one tool, wherein cutting tool 18 and marking nib 28 are both held in the same head 30. After cutting tool 18 has been used to cut the inner surface 20, cutting tool 18 is brought out of cavity 14, head 30 is rotated to bring marking nib 28 into alignment with cavity 14, and nib 28 is inserted into cavity 14 and aligned with a selected area of inner surface 20 for drawing reference marking 26. FIG. 1B shows nib 28 inking a first reference marking 26 in the tubular body 12, and FIG. 1C shows nib 28 moved axially to ink a second reference marking 26. By using the same machine tool setup for cutting and marking, significant savings are realized in time, labor and cost of manufacture. Of course, significant savings are also realized even if body 12 is molded with no cutting operations.

Reference marking 26 is made by imparting relative motion between nib 28 and inner surface 20. As described hereinabove for cutting tool 18, this means that marking nib 28 may be generally stationary while inner surface 20 is rotated relative to nib 28, or alternatively, inner surface 20 may be generally stationary while nib 28 is rotated.

Different kinds of marking nibs may be used to carry out the invention. For example, marking nib 28 may contact the inner surface 20 during inking, as seen in FIGS. 1B and 1C. Alternatively, as seen in FIG. 2, an ink-jet marking nib 32 may be used to ink jet ink upon inner surface 20 to form reference 26. It is noted that throughout the specification and claims the term “ink jet” is used to encompass any kind of printing action wherein the marking nib does not necessarily contact the printing surface, such as spraying, jetting, squirting or dripping ink on the printing surface.

Another option of the invention is shown in FIG. 1A. A groove 34 may be formed, such as with some cutting tool or as part of the mold of body 12, in inner surface 20 of body 12. Reference marking 26 may then subsequently be inked in groove 34.

Reference is now made to FIG. 4 which illustrates a finished tubular bubble vial 36, constructed and operative in accordance with a preferred embodiment of the present invention. Tubular bubble vial 36 has a pair of reference markings 26 formed on at least a portion of the internal circumference (i.e., inner surface 20) of body 12, generally transverse to a longitudinal axis 38 of body 12. A fluid 16 (e.g., mineral spirits, kerosene, or the like) is encapsulated within the inner cavity of body 12 with an air space providing a visible bubble 40. The finished vial 36 is sealed, such as by means of a plug 42.

Reference is now made to FIG. 5 which illustrates a finished spherical bubble vial 44, of the familiar bull's-eye type. Bubble vial 44 is of generally spherical shape with an internal dome 46, and there is a reference marking 48, of generally circular shape, on at least a portion of internal dome 46. A fluid 16 is encapsulated within the inner dome 46 with an air space providing a visible bubble 50. The finished vial 44 is sealed, such as by sonic welding or other joining methods, to a sealing base 52.

It will be appreciated by person skilled in the art, that the present invention is not limited by what has been particularly shown and described herein above. Rather the scope of the present invention is defined only by the claims that follow:

What is claimed is:

1. A method for marking a bubble vial, comprising:
providing a bubble vial body having an internal cavity for holding therein a fluid, the cavity defining an inner surface of the body; and
inking a reference marking on said inner surface.

2. The method according to claim 1 wherein said inking comprises inserting inside the cavity a marking nib, said nib being adapted for applying an ink line on a surface, aligning said nib with a selected area of said inner surface and imparting relative motion between said nib and said inner surface so as to form said reference marking on said inner surface.

3. The method according to claim 2 wherein said marking nib is generally stationary and said inner surface of said bubble vial body is moved relative to said nib.

4. The method according to claim 2 wherein said inner surface of said bubble vial body is generally stationary and said marking nib is moved relative to said inner surface of said bubble vial body.

5. The method according to claim 2 wherein said nib contacts said inner surface during said inking.

6. The method according to claim 2 wherein said marking nib is adapted to ink jet ink upon a surface, and said inking comprises ink jetting said reference marking on said inner surface.

7. The method according to claim 1 and further comprising, prior to said inking, machining said inner surface.

8. The method according to claim 7 wherein said machining is performed with a cutting tool held in a machine tool setup, and said inking comprises inserting inside the cavity a marking nib held in said machine tool setup, said nib being adapted for applying an ink line on a surface, aligning said nib with a selected area of said inner surface and imparting relative motion between said nib and said inner surface so as to form said reference marking on said inner surface.

9. The method according to claim 1 wherein said inner surface comprises a non-absorbent surface and said inking comprises forming said reference marking with an ink having an ink film fixability sufficient for adhering to said non-absorbent surface.

10. The method according to claim 1 and further comprising forming a groove in said inner surface and wherein said inking comprises forming said reference marking in said groove.

11. The method according to claim 1 wherein said bubble vial body is of generally tubular shape with an internal circumference, and said inking comprises forming said reference marking on at least a portion of said internal circumference, generally transverse to a longitudinal axis of said bubble vial body.

12. The method according to claim 1 wherein said bubble vial body is of generally spherical shape with an internal dome, and said inking comprises forming said reference marking on at least a portion of said internal dome.

13. A bubble vial comprising:
a bubble vial body having an internal cavity for holding therein a fluid, the cavity defining an inner surface of the body; and
a reference marking inked on said inner surface.

14. The bubble vial according to claim 13 wherein said inner surface comprises a non-absorbent surface and said reference marking is formed with an ink having an ink film fixability sufficient for adhering to said non-absorbent surface.

15. The bubble vial according to claim 13 wherein said inner surface is formed with a groove and said reference marking is inked in said groove.

16. The bubble vial according to claim 13 wherein said bubble vial body is of generally tubular shape with an internal circumference, and said reference marking is formed on at least a portion of said internal circumference, generally transverse to a longitudinal axis of said bubble vial body.

17. The bubble vial according to claim 13 wherein said bubble vial body is of generally spherical shape with an internal dome, and said reference marking is formed on at least a portion of said internal dome.
